(19) United States
(12) Patent Application Publication
(10) Pub. No.: US 2006/0108222 A1
(43) Pub. Date: May 25, 2006

(54) Gas sensor with protective cover having higher water wettability

(75) Inventors: Kohei Yamada, Oobu-shi (JP); Tomofumi Fujii, Okazaki-shi (JP); Katsuhiko Nakabayashi, Handa-shi (JP); Satoshi Hayashi, Kuwana-shi (JP); Masato Ozawa, Toyota-shi (JP); Takashi Kojima, Kasugai-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/286,417

(22) Filed: Nov. 25, 2005

(30) Foreign Application Priority Data
Nov. 24, 2004 (JP) 2004-339245
Jun. 23, 2005 (JP) 2005-182983
Oct. 3, 2005 (JP) 2005-290322

(51) Int. Cl. G01N 27/26

(52) U.S. Cl. 204/431; 204/430

(57) ABSTRACT

A gas sensor such as an O₂ sensor or NOx sensor used in measuring an air-fuel ratio of a mixture supplied to an automotive internal combustion engine. The gas sensor is equipped with a sensor element and a cover assembly. The cover assembly is coated with a hydrophilic film having a water wettability of 70° or less, as expressed by a water contact angle, or reformed to have a surface having a water wettability of 70° or less. This minimizes exposure of the sensor element to water without sacrificing the response of the gas sensor to avoid water-caused cracks in the sensor element.

### CROSS REFERENCE TO RELATED DOCUMENT

The present application claims the benefit of Japanese Patent Application No. 2004-339245 filed on Nov. 24, 2004, Japanese Patent Application No. 2005-182983 filed on Jun. 23, 2005, and Japanese Patent Application No. 2005-290322 filed on Oct. 3, 2005, the disclosures of which are incorporated herein by reference.

### BACKGROUND OF THE INVENTION

1. Technical Field of the Invention

The present invention relates generally to a gas sensor which may be installed in an exhaust pipe of an internal combustion engine to measure the concentration of a specified component of exhaust emissions of the engine, and more particularly to such a gas sensor equipped with a sensor element protective cover having an enhanced water-wettability to minimize exposure of a sensor element to water.

2. Background Art

FIG. 14 shows an example of typical gas sensors installed in an exhaust system of an automotive internal combustion engine to measure the concentration of oxygen contained in exhaust gas G which is used in determining an air-fuel ratio of a mixture supplied to the engine for engine burning control.

The gas sensor 9 has retained therein a sensor element 92 made of a solid electrolyte material such as zirconia and a protective cover assembly 93. The protective cover assembly 93 is made of metal such as a stainless steel and has gas inlets 933 through which the exhaust gas G is admitted thereinto.

The exhaust gas G flows inside the cover assembly 93 through the gas inlets 933 and reaches the sensor element 92. The sensor element 92 is sensitive to oxygen (O₂) contained the exhaust gas G and output a signal as a function of the concentration of oxygen.

When the engine is in a cold condition, moisture contained in the exhaust gas G may stick to an inner wall of the exhaust pipe having been cooled during stop of the engine, so that it condenses into water drops. Particularly, when the temperature of the exhaust gas G is low immediately after start-up of the engine, it will cause the water drops to be blown away by the exhaust gas G and enter the cover assembly 93.

The accurate measurement of oxygen requires heating the sensor element 92 up to as high as 400° C. and keeping it activated. This may cause thermal damage to the sensor element 92 when the water drops enter the cover assembly 93 and stick to the sensor element 92. In the worst case, the sensor element 92 cracks.

In order to avoid the exposure of the sensor element 92 to water, the cover assembly 93 is designed to have a double-wall structure made up of an inner cover 931 and an outer cover 932 and the gas inlets 933 arranged out of coincidence with each other in a radius direction of the cover assembly 93.

However, when sticking to the outer surface 934 of the outer cover 932, the water drops W may move along the outer surface 934 to the gas inlets 933 and enter inside the outer cover 931. The water drops W may further move along the outer surface 936 of the inner cover 931 and the inner surface 935 of the outer cover 932 to the gas inlets 933 of the inner cover 931 and enter inside the inner cover 931, so that they stick to the sensor element 92 and causes the cracks in the sensor element 92.

In order to avoid the above problem, Japanese Patent First Publication No. 8-240559 teaches, as illustrated in FIG. 15, use of a water repellent protective layer 94 which wraps the sensor element 92. The use of the protective layer 94, however, results in an increase time required by the exhaust gas to reach a sensing portion of the sensor element 92, which leads to a decrease in response time of the gas sensor 9, and also an increase in thermal capacity of the sensor element 92, thus contributing an increase in time required to activate the sensor element 92.

Japanese Utility Model First Publication No. 4-11461 discloses, as illustrated in FIG. 16, a gas sensor 90 equipped with a protective layer 940 covering gas inlets 933 of a protective cover 93. This structure, however, also results in an increase time required by the exhaust gas to enter inside the protective cover 93 and reach the sensor element 920, which leads to a decrease in response time of the gas sensor 90.

### SUMMARY OF THE INVENTION

It is therefore a principal object of the invention to avoid the disadvantages of the prior art.

It is another object of the invention to provide an improved structure of a gas sensor equipped with a sensor element protective cover having an enhanced water-wettability to minimize exposure of a sensor element to water without sacrificing the response of the gas sensor.

According to one aspect of the invention, there is provided a gas sensor such as an O₂ sensor or a NOx sensor used to measure the concentration of O₂ or NOx contained in exhaust emissions of an automotive internal combustion engine. The gas sensor comprises: (a) a sensor element sensitive to a specified component of gases to provide a signal as a function of concentration of the specified component; and (b) a cover covering said sensor element. The cover has gas inlets through which the gasses pass and enter a gas chamber to which said sensor element is exposed within said cover. The cover has formed thereon a hydrophilic film which enhances wettability of a surface of the cover.

The hydrophilic film exhibits the hydrophilic property and the water-absorbing property and works to hold water drops sticking to the cover from moving thereon. The water drops staying on the cover are subjected to heat transmitted from the cover and evaporated, thereby minimizing exposure of the sensor element to water and avoiding cracks in the sensor element. Specifically, a lower water-wettability, that is, a higher water repellency will cause the water drops to be vaporized only at surfaces thereof by the heat of the cover, thus resulting in the film boiling in which the water drops are wrapped in water vapors. This requires much time for vaporizing the water drops completely.

The hydrophilic film does not block the gas inlets, thus ensuring a desired response time of the gas sensor.

In the preferred mode of the invention, the cover is of a double-wall structure made up of an outer cover and an inner cover. The hydrophilic film is coated on an outer surface of the inner cover.

The gas sensor further comprises a hydrophilic film formed on an inner surface of the outer cover.

Each of the hydrophilic films has a water-wettability of 70° or less, as expressed by a water contact angle.

Each of the hydrophilic films may have a water-wettability of 60° or less, as expressed by the water contact angle.

Each of the hydrophilic films may be made of an inorganic porous material such as a sintered metal

Each of the hydrophilic films may be implemented by an oxide film formed on said cover made of metal.

The oxide film may be formed by thermally treating said cover in air.

According to the second aspect of the invention, there is provided a gas sensor which comprises: (a) a sensor element sensitive to a specified component of gases to provide a signal as a function of concentration of the specified component; and (b) a cover covering said sensor element. The cover has gas inlets through which the gasses pass and enter a gas chamber to which said sensor element is exposed within said cover. The cover has a surface reformed to have an enhanced water-wettability.

In the preferred mode of the invention, the cover is of a double-wall structure made up of an outer cover and an inner cover. An outer surface of the inner cover is reformed to have the enhanced water-wettability.

An inner surface of the outer cover is also reformed to have an enhanced water-wettability.

The water-wettability of the surface of said cover is 70° or less, as expressed by a water contact angle.

The water-wettability of the surface of said cover may alternatively 60° or less, as expressed by the water contact angle.

The outer surface of the inner cover may be mechanically treated to have the water-wettability.

The outer surface of the inner cover may alternatively be electrochemically treated to have the water-wettability.

According to the third aspect of the invention, there is provided a gas sensor which comprises: (a) a sensor element sensitive to a specified component of gases to provide a signal as a function of concentration of the specified component; and (b) a cover covering said sensor element. The cover has gas inlets through which the gasses pass and enter a gas chamber to which said sensor element is exposed within said cover. The cover is made of an inorganic porous material having a water-wettability of 70° or less, as expressed by a water contact angle.

The porous material may be a sintered metal.

According to the fourth aspect of the invention, there is provided a gas sensor which comprises: (a) a sensor element sensitive to a specified component of gases to provide a signal as a function of concentration of the specified component; and (b) a cover assembly cover covering said sensor element. The cover has gas inlets through which the gasses pass and enter a gas chamber to which said sensor element is exposed within said cover assembly. The cover assembly is of a double-wall structure made up of an outer cover and an inner cover disposed inside the outer cover. At least one of an outer surface of the inner cover and an inner surface of the outer cover has a water-wettability of 70° or less, as expressed by a water contact angle.

The least one of the outer surface of the inner cover and the inner surface of the outer cover may alternatively have a water-wettability of 60° or less, as expressed by a water contact angle.

The at least one of the outer surface of the inner cover and the inner surface of the outer cover is smaller in water-wettability than an outer surface of the outer cover.

The at least one of the outer surface of the inner cover and the inner surface of the outer cover may be coated with an inorganic porous material.

The at least one of the inner cover and the outer cover may alternatively be made of an inorganic porous material.

The porous material may be made of a thermally sprayed film such as an alumina film.

The inner cover and the outer cover may be each made of a stainless steel. The thermally sprayed film may be made of a stainless steel.

The inner cover and the outer cover may be both made of a porous material.

The porous material may be a sintered metal.

According to the fifth aspect of the invention, there is provided a gas measuring apparatus for an internal combustion engine which comprises: (a) an exhaust pipe leading to an internal combustion engine; (b) a gas sensor installed in said exhaust pipe, said gas sensor being sensitive to a specified component of gases to provide a signal as a function of concentration of the specified component; and (c) a hydrophilic film affixed to an inner wall of said exhaust pipe at a location upstream of said gas sensor. The hydrophilic film has a water-wettability of 70° or less, as expressed by a water contact angle.

According to the sixth aspect of the invention, there is provided a gas measuring apparatus for an internal combustion engine which comprises: (a) an exhaust pipe leading to an internal combustion engine; and (b) a gas sensor installed in said exhaust pipe. The gas sensor is sensitive to a specified component of gases to provide a signal as a function of concentration of the specified component. A portion of an inner wall of said exhaust pipe located upstream of said gas sensor is reformed to have a water-wettability of 70° or less, as expressed by a water contact angle.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially longitudinal sectional view which shows a gas sensor according to the first embodiment of the invention;

FIG. 2 is an enlarged view of FIG. 1;

FIG. 3 is a sectional view which shows a test sample of a gas sensor installed in an exhaust pipe of an automotive internal combustion engine;

FIG. 4 is a graph which demonstrates a relation between the amount of water adhered to a sensor element and the amount of water injected into the exhaust pipe of FIG. 3 which was found in tests carried out in the manner, as illustrated in FIG. 3;

FIG. 5 is a graph which demonstrates activation times consumed to activate an invention sensor test sample and a comparative sensor test sample;

FIG. 6 is a graph which demonstrates 63%-response times of an invention sensor test sample and a comparative sensor test sample;

FIG. 7 is a view which shows a change in sensor output following a change in air-fuel ratio of an internal combustion engine;

FIG. 8 is a partially longitudinal sectional view which shows a gas sensor according to the second embodiment of the invention;

FIG. 9 is a partially longitudinal sectional view which shows a gas sensor according to the third embodiment of the invention;

FIG. 10 is a partially longitudinal sectional view which shows a gas sensor according to the sixth embodiment of the invention;

FIG. 11 is a sectional view which shows a gas measuring apparatus according to the seventh embodiment of the invention;

FIG. 12 is a graph which demonstrates an experimentally found relation between a water contact angle and a percentage of exposure of test pieces to water;

FIG. 13 is a graph which demonstrates an experimentally found relation between the temperature of test pieces and the time for which a water drop remains on the test piece being heated;

FIG. 14 is a partially longitudinal sectional view which shows an example of a conventional gas sensor;

FIG. 15 is a partially longitudinal sectional view which shows another example of a conventional gas sensor; and

FIG. 16 is a partially longitudinal sectional view which shows another example of a conventional gas sensor.

### DESCRIPTION OF THE PREFERRED EMBODIMENTS

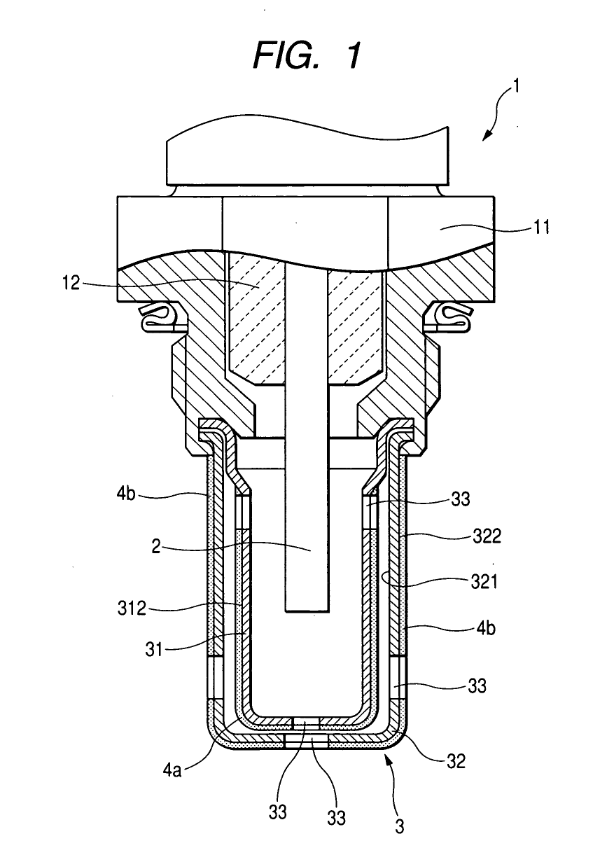

Referring now to the drawings, particularly to FIG. 1, there is shown a gas sensor 1 according to the first embodiment of the invention. The gas sensor 1 may be installed in an exhaust pipe of an automotive internal combustion engine to measure the concentration of oxygen (O₂) or NOx contained in exhaust emissions for use in determining an air-fuel ratio of a mixture supplied to the engine for burning control of the engine.

The gas senor 1 has built therein a sensor element 2 working to measure the concentration of a specified gas. The gas sensor 1 also includes a cylindrical double-walled protective cover assembly 3 which has gas inlets 33 formed therein. The cover assembly 3 is made up of an inner cover 31 and an outer cover 32 enclosing the inner cover 31 coaxially.

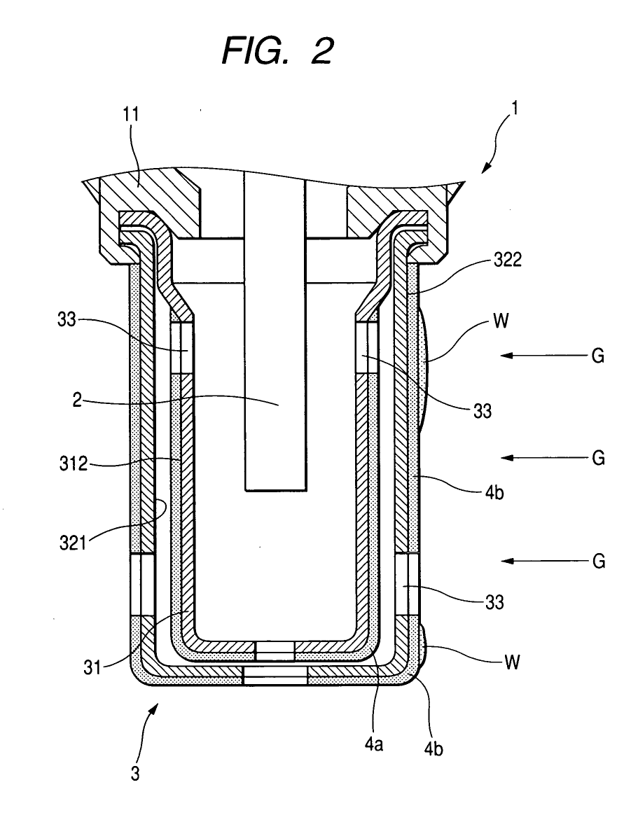

The inner cover 31, as clearly illustrated in FIG. 2, has an outer surface 312 coated with a thermally sprayed porous film 4a. Similarly, the outer cover 32 has an outer surface 322 coated with a thermally sprayed porous film 4b. Each of the inner and outer covers 31 and 32 is formed by pressing a rolled stainless steel. Similarly, the porous films 4a and 4b are formed by thermally spraying a stainless steel on the outer surfaces 312 and 322, respectively. Each of the porous films 4a and 4b may also be made of an inorganic material such as alumina.

The porous films 4a and 4b may have a porosity of 4% to 50% and a thickness of 50 μm to 100 μm. When the porosity is less than 4%, it results in a lack in water-absorbing property, as will be discussed later. Conversely, when the porosity is greater than 50%, it results in a difficulty in retaining water to degrade the water-absorbing property. When the thickness is less than 50 μm, it results in a lack in water-absorbing property. When the thickness is more than 100 μm, it results in an increased overall thickness of the cover assembly 3, thus increasing the thermal capacity of the cover. This results in a difficulty in heating the cover up to a temperature required to evaporate water drops sticking to the cover assembly 3. In this embodiment, the porosity is 5%. The thickness is 100 μm.

The porous films 4a and 4b also have a wettability of 70° or less, as expressed by the water contact angle between the surface of the films 4a and 4b and the surface of water.

The gas sensor 1, as illustrated in FIG. 1, a cylindrical housing 11 to be installed in an exhaust pipe of an automotive internal combustion engine. The sensor element 2 is retained inside the housing 11 through a porcelain insulator 12. The sensor element 2 consists essentially of a solid electrolyte body made mainly of zirconia, a reference gas-exposed electrode (not shown) affixed to an inner surface thereof, and a measurement gas-expose electrode (not shown) affixed to an outer surface thereof. The sensor element 2 also has a heater (not shown) working to heat the sensor element 2 up to 400° C. or more for keeping it in a desired activated state. For example, U.S. Pat. No. 6,222,372 issued on Apr. 24, 2001, assigned to the same assignee as that of this application, teaches a gas sensor of the type as referred to herein, the disclosure of which is incorporated herein by reference.

The cover assembly 3 is joined to an end of the housing 11. Such joining is achieved by inserting an open end of the cover assembly 3 into an annular groove formed in the end of the housing 111 and crimping an annular extension around the annular groove inwardly. The inner and outer covers 31 and 32 have the gas inlets 33 through which the exhaust gas of the automotive engine (i.e., the gas to be measured) passes and enter a gas chamber defined inside the inner cover 31. One of the gas inlets 33 formed in the bottom of the inner cover 31 coincides with one of the gas inlets 33 formed in the bottom of the outer cover 32 in the longitudinal direction of the cover assembly 3. The other gas inlets 33 of the inner cover 31 do not overlap spatially with those of the outer cover 32 in the radius direction of the cover assembly 3.

The outer surfaces 312 and 322 of the inner and outer covers 31 and 32 are, as described above, covered with the porous films 4a and 4b, respectively, which serve as a hydrophilic film having a water-wettability of 70° or less. In use of the gas sensor 1, the porous films 4a and 4b, therefore, work to minimize the entrance of drops of water into the cover assembly 3 which have been carried by flows of the measurement gas and adhered to the outer surface of the cover assembly 3.

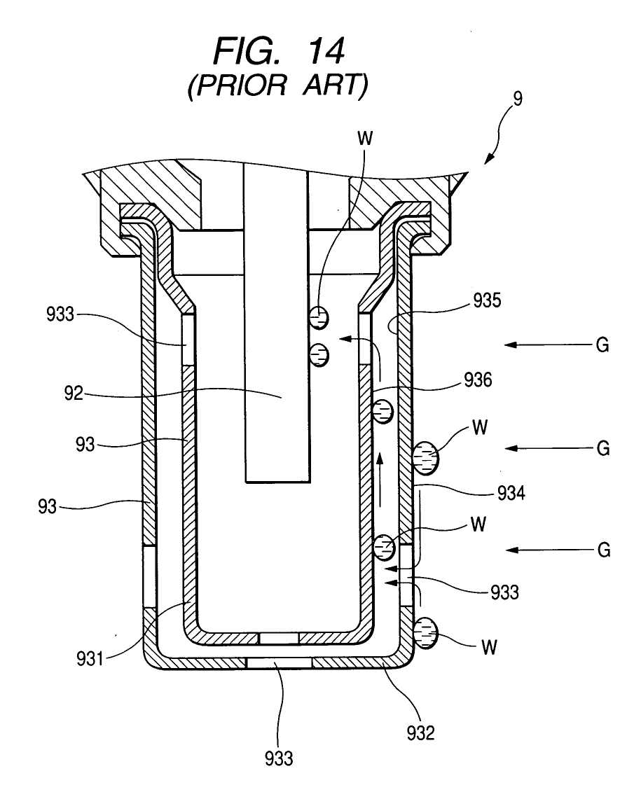

Specifically, as illustrated in FIG. 2, the water drops W carried by the flows G of the measurement gas first stick to the outer surface 322 of the outer cover 32. In the absence of the porous films 4a and 4b, the water drops W usually slide on the outer surface 322 and enter inside the outer cover 32 at the gas inlets 33 (see FIG. 14). The water drops W further slide on the outer surface 312 or the inner surface 321 of the outer cover 32 and enter inside the inner cover 31 through the gas inlets 33.

The porous film 4b on the outer cover 32 has, as described above, a water-wettability of 70° or less and exhibits the hydrophilic property and the water-absorbing property, thus working to hold the water drops W sticking to the outer cover 32 from moving thereon.

Similarly, the porous film 4a on the inner cover 31 which works to minimize the movement of the water drops W on a gas flow path extending from the gas inlets 33 of the outer cover 32 to the gas inlets 33 of the inner cover 31.

The water drops W staying on either of the inner cover 31 or the outer cover 32 are vaporized by the heat of the cover assembly 3 elevated in temperature during use of the gas sensor 1, thereby protecting the sensor element 2 from the water exposure to avoid water-caused cracks therein.

The porous films 4a and 4b have a higher water-wettability, thus facilitating, as described above, quick vaporization of the water drops W sticking to the cover assembly 3. Specifically, a lower water-wettability, that is, a higher water repellency will cause the water drops W to be vaporized only at the surfaces thereof by the heat of the cover assembly 3, thus resulting in the film boiling in which the water drops W are wrapped in water vapors. This requires much time for vaporizing the water drops W completely.

The porous films 4a and 4b do not cover the gas inlets 3 of the inner and outer covers 31 and 33, thus permitting the flows G of the measurement gas to enter inside the inner cover 31 to ensure a desired degree of response of the gas sensor 1.

We performed tests, as discussed below, to evaluate the beneficial effects of use of the porous films 4a and 4b.

We prepared two types of test samples 100: one having the same structure as that of the gas sensor 1 equipped with the porous films 4a and 4b, and the second having the same structure as that of the gas sensor 1, but not equipped with the porous films 4a and 4b and observed the adhesion of water to the sensor element 2 of the test samples in the following manner. The former sample 100 will also be referred to as an invention sample, while the latter sample 100 will also be referred to as a comparative sample below.

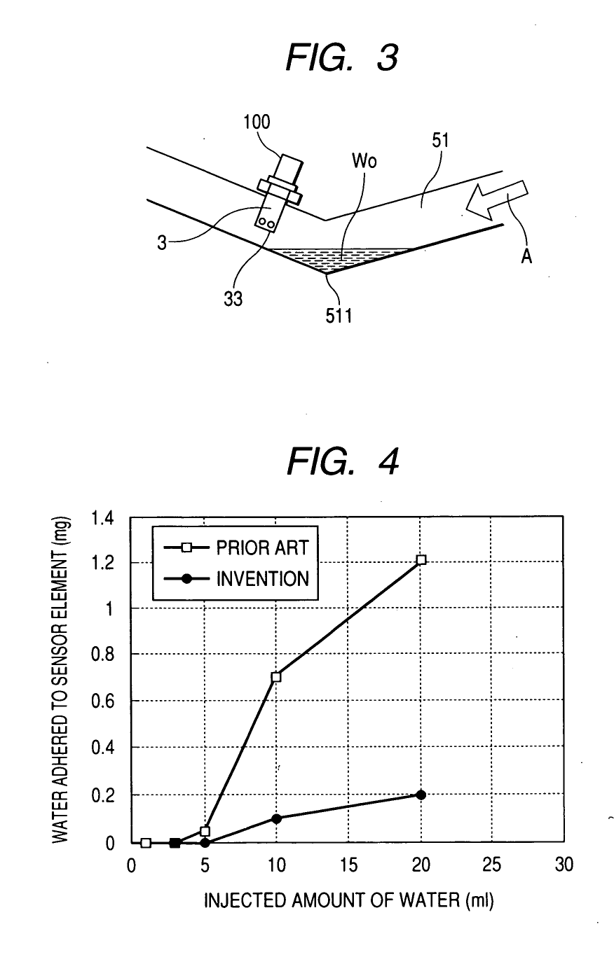

We prepared, as shown in FIG. 3, a pipe 51 bent at approximately 150° C. and placed it with a bend 511 faced down. We installed each of the test samples 100 in the pipe 51 100 mm away from the bent 511 and put water Wo in the pipe 51 near the bent 511.

Subsequently, we blown air into the pipe 51 from an end thereof remote from the test sample 100 across the bend 511 at a pressure equivalent to that of exhaust gasses when the internal combustion engine is running at 4300 rpm to splash the water Wo over the test sample 100. We observed the entrance of the part of water Wo into the cover assembly 3 and adhesion to the sensor element 2 and measured the weight of water Wo adhered to the sensor element 2. We performed this test on each of the invention and comparative samples 100 in five cases where the amounts of water Wo injected into the pipe 51 were 1 ml, 3 ml, 5 ml, 10 ml, and 20 ml.

FIG. 4 is a graph which demonstrates results of measurements in the above tests. “●” indicates the weight of water Wo adhered to the sensor element 2 of the invention sample 100. “□” indicates the weight of water Wo adhered to the sensor element 2 of the comparative sample 100. The graph shows that the greater the amount of water Wo injected into the pipe 51, the greater the degree of adhesion of water Wo to the sensor element 2 in each of the invention and comparative samples 100, but such a degree of adhesion will decrease greatly in the invention sample 100.

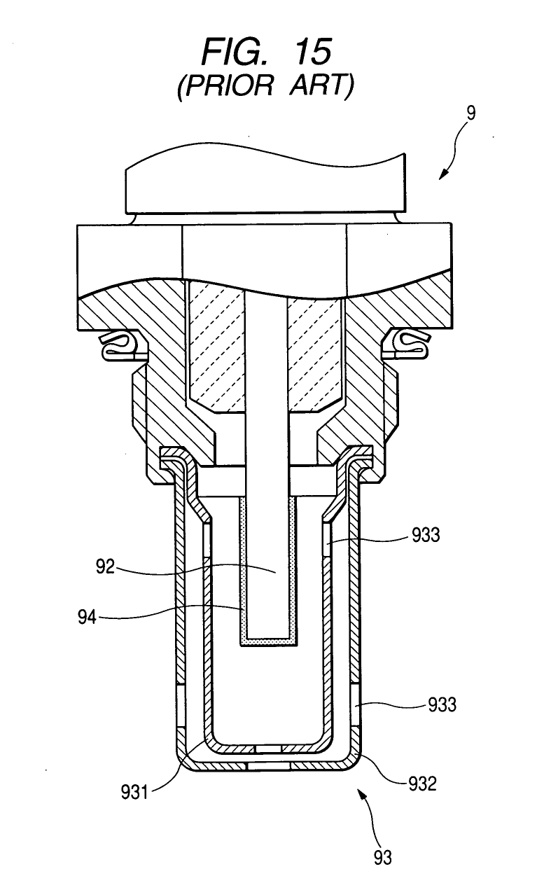

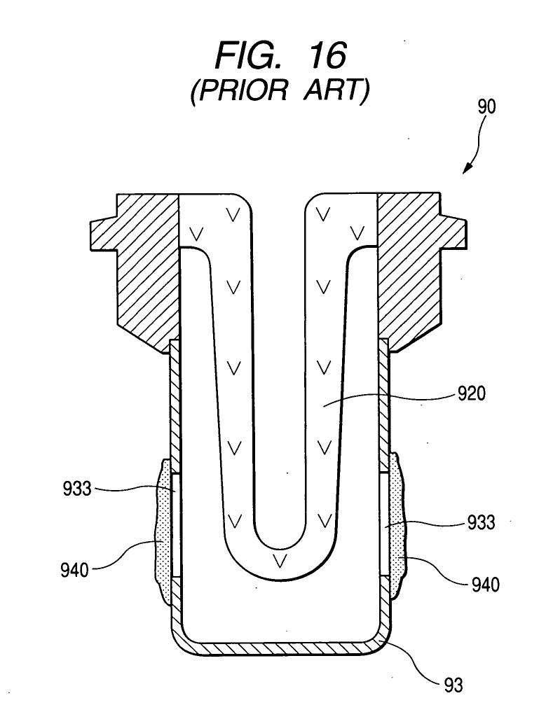

We also performed activation time tests to evaluate the time required to activate the sensor element 2. We prepared an invention sample having the same structure as that of the gas sensor 1 and a comparative sample having the same structure as that of the gas sensor 9 illustrated in FIG. 15 in which the sensor element 92 is covered with the protective layer 94.

We placed each of the invention sample and the comparative sample in air, applied 5V to a built-in heater, and measured the time required to heat one of the sensor elements 2 and 92 up to 700° C. from the room temperature.

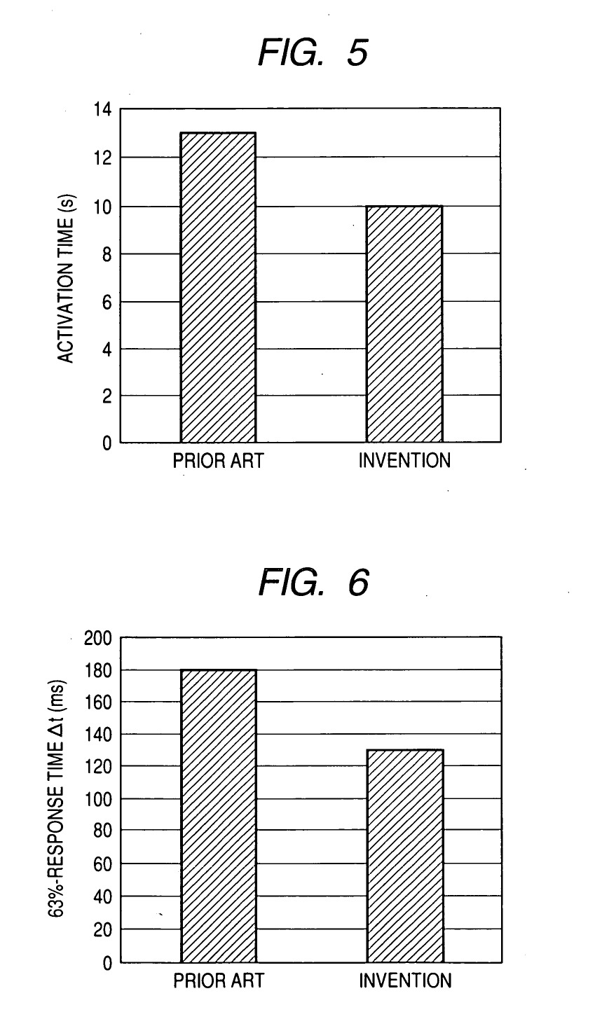

FIG. 5 is a graph which demonstrates results of the above measurements. The graph shows that the comparative sample required 13 minutes until the sensor element 92 was heated up to 700° C., while the invention sample required 10 minutes.

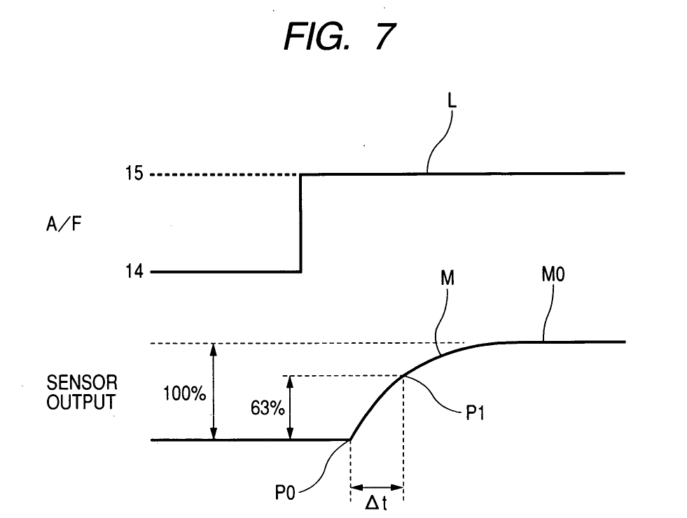

We also performed sensor response tests on an invention sample having the same structure as that of the gas sensor 1 and a comparative sample having the same structure as the gas sensor 9 illustrated in FIG. 15 in which the sensor element 92 is covered with the protective layer 94. We installed each of the samples in an exhaust pipe leading to an automotive 3-liter internal combustion engine, run the engine at 1500 rpm, switched the air-fuel ratio of the mixture supplied to the engine between A/F=14 and A/F=15, and measured a 63%-response time Δt of the sample. Usually, when the A/F ratio is switched, as indicated by a line L in FIG. 7, from 14 to 15, an output of a gas sensor of the same type as the gas senor 1 will change, as indicated by a line M, following the switching of the A/F ratio. The output consumes some time until it converges completely. If the amount of change in the output of the gas sensor from point P0 where the output of the sensor starts to change to point M0 where it has converged completely is defined as 100%, the time required for the output to build up to 63% is referred to herein as the 63%-response time Δt.

FIG. 6 is a graph which demonstrates the 63%-response times Δt, as measured in the invention and comparative samples. The graph shows that the 63%-response time of the comparative sample is 180 msec., while that of the invention sample is 130 msec. and that the gas sensor 1 of this embodiment is excellent in response time.

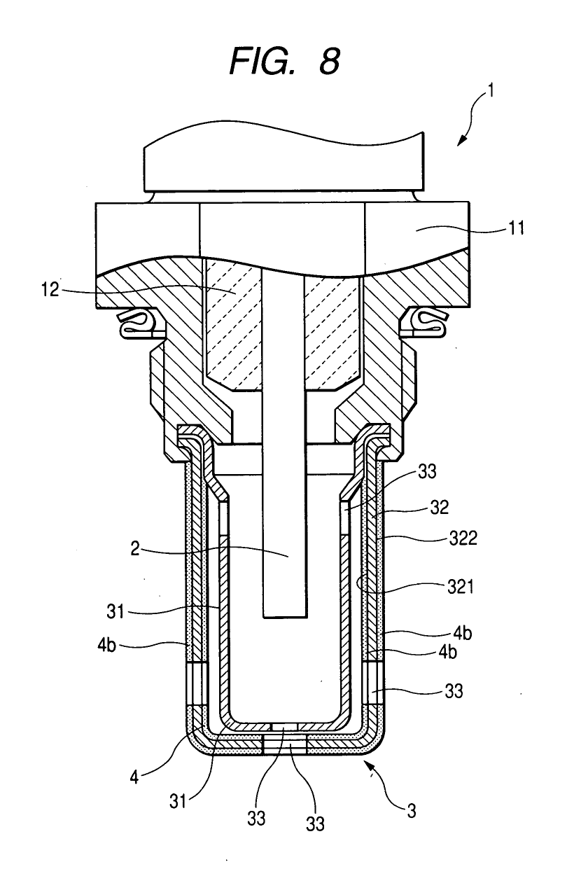

FIG. 8 shows the gas sensor 1 according to the second embodiment of the invention.

The outer cover 32 has the outer surface 322 and the inner surface 321 which are both coated with the porous films 4b. The inner cover 31 does not have the porous film 4a. Other arrangements are identical with those in the first embodiment, and explanation thereof in detail will be omitted here.

The gap between the inner cover 31 and the outer cover 32 is, for example, as small as 0.5 mm to 2 mm, thus facilitating adhesion of water drops to the inner and outer covers 31 and 32. The porous film 4a on the inner surface 321 of the outer cover 32, however, serves to have the water drops stick thereto through the hydrophilic property and the water-absorbing property thereof, thereby minimizing the entrance of the water drops inside the inner cover 31.

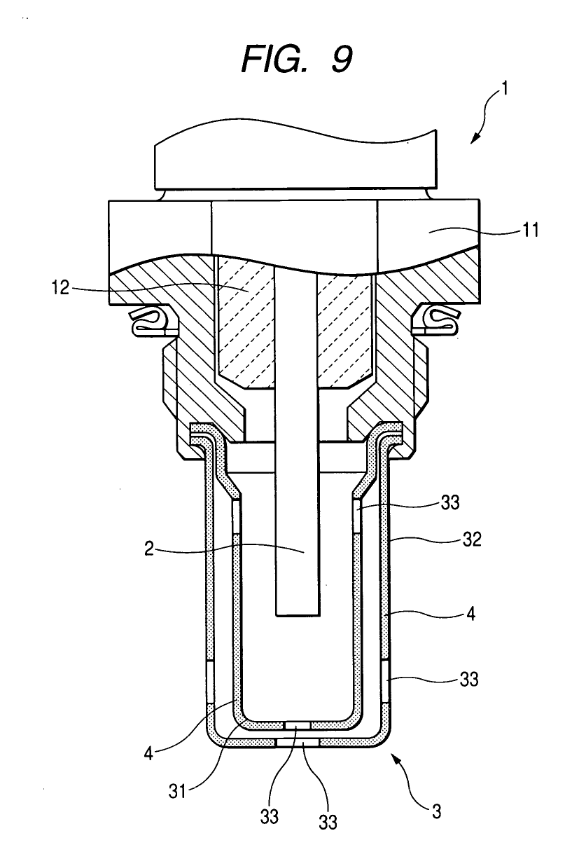

FIG. 9 shows the gas sensor 1 according to the third embodiment of the invention.

The inner cover 31 and the outer cover 32 are made of a sintered metallic porous material 4 in themselves. Other arrangements are identical with those in the first embodiment, and explanation thereof in detail will be omitted here.

The fourth embodiment of the gas sensor 1 will be described below which is a modification of the first embodiment.

The porous film 4a and the porous film 4b are formed on the inner and outer surfaces of the inner cover 31 and the inner and outer surfaces of the outer cover 32, respectively, and each made of an oxide film which is easy to form. The formation of the oxide films is achieved by placing the inner cover 31 and the outer cover 32 in air and heating them up to 800° C. to 900° C. using an oxidizing furnace.

Either of the inner cover 31 or the outer cover 32 may be covered with the oxide film. The porous films 4a and 4b may alternatively be made of a ceramic porous material such as alumina or a sintered metal. Other arrangements of the gas sensor 1 are identical with those in the first embodiment, and explanation thereof in detail will be omitted here.

The fifth embodiment of the gas sensor 1 will be described below in which the surfaces of the inner cover 31 and the outer cover 32 are reformed to enhance the water-wettability.

Specifically, the reforming is achieved by machining or chemically treating the surfaces of the inner and outer covers 31 and 33. The machining may be implemented by shot-blasting or barreling. The chemical treatment may be implemented by chemical grinding or polishing or electrolytic polishing. Other arrangements of the gas sensor 1 are identical with those in the first embodiment, and explanation thereof in detail will be omitted here.

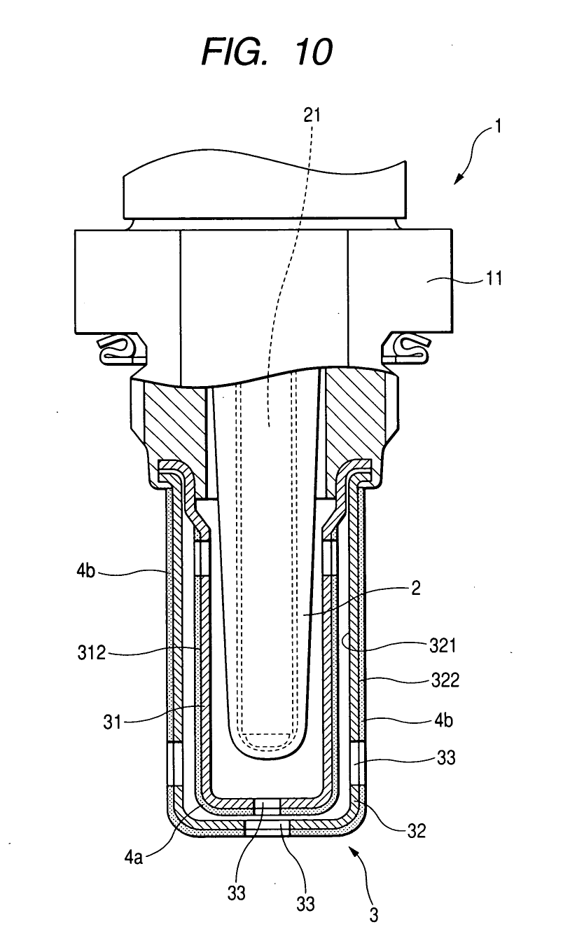

FIG. 10 shows the gas sensor 1 according to the sixth embodiment of the invention.

The gas sensor 1 is equipped with the U- or cup-shaped sensor element 2 in which the ceramic heater 21 is retained. The structure of the cover assembly 3 is identical with that in the first embodiment.

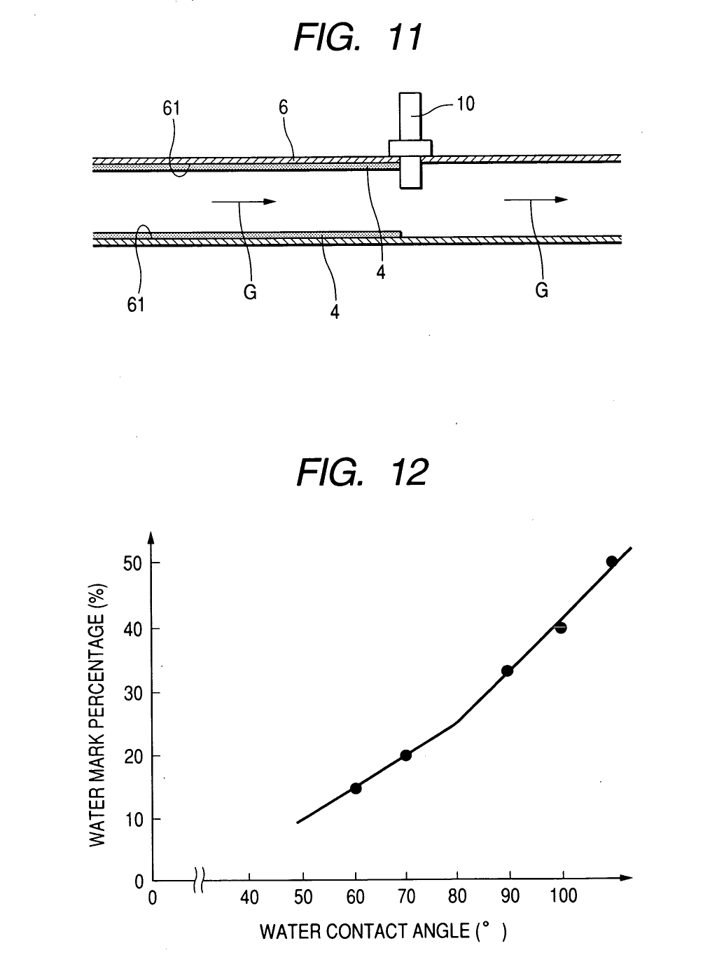

FIG. 11 shows a gas measuring apparatus according to the seventh embodiment of the invention which is designed, for example, to measure the concentration of a specified component of exhaust emissions of an internal combustion engine.

The gas measuring apparatus includes an exhaust pipe 6 leading to the engine and a gas sensor 10. The gas sensor 10 is of a typical structure known in the art or may have the structure, as discussed in any one of the first to sixth embodiments.

The gas sensor 10 is installed in the exhaust pipe 6. The exhaust pipe 6 has the cylindrical porous film 4 formed over a portion of an inner wall 61 thereof upstream of the exhaust gas G from the gas sensor 10. The porous film 4 is, like the above embodiments, a hydrophilic film having a water-wettability of 70° or less.

The porous film 4 may be made of an oxide film, a thermally sprayed film (e.g., an inorganic material such as alumina), a sintered metallic film, or a ceramic porous film.

Instead of the porous film 4, the inner surface 61 of the exhaust pipe 6 may be reformed by the shot-blasting, the barreling, the chemical grinding or the electrolytic polishing.

The moisture carried by a flow of the exhaust gas G sticks to the porous film 4 on the inner surface 61 of the exhaust pipe 6 before reaching the gas sensor 10 and then is vaporized quickly by the heat transmitted from the inner surface 61, thereby minimizing the adhesion of the moisture to the gas sensor 10 to avoid water-caused cracks in a sensor element built in the gas sensor 10.

FIG. 12 is a graph which demonstrates a relation between a water contact angle and a percentage of exposure to water we found experimentally.

We prepared five types of sensor samples which had the same structure as that of the gas sensor 1 of the first embodiment, but were different from each other in angle between a portion of the surface of the cover assembly 3 of contact with a water drop and the outer surface of the water drop (will also be referred to as a water contact angle below) which was created by differing the condition of the surface of the cover assembly 3 of the sensor samples.

The water contact angles were measured using a drop master, as manufactured by Kyowa InterFACE Science Co., LTD in Japan, in the condition that the drop master was placed horizontally to the surface of the cover assembly 3 of contact with the water drop staying on the cover assembly 3. Each of the water contact angles, as plotted in FIG. 12, is an average of measurements of each sensor sample carried out at any three points on an outer area of the inner cover 31 between one of the gas inlets 33 of the outer cover 32 and one of the gas inlets 33 of the inner cover 31.

We installed each of the sensor samples in the exhaust pipe of a 3000 cc gasoline engine and observed the degree of exposure of the sensor element 2 to water during running of the engine. We stained the surface of the sensor element 2 of each sensor sample, measured an area of a mark appearing on the stained surface caused by adhesion of water thereto, and calculate a water mark percentage that is the percentage of the measured area in an overall area of the outer surface of the cover assembly 3.

We run the engine at 1000 rpm to 3000 rpm for one minute. We drilled a through hole in a portion of the exhaust pipe between the engine and the sensor sample and injected 10 cc water into the hole upstream of the sensor sample during the running of the engine to create the same condition as that when the engine has started at low temperature to cause moisture contained in the exhaust gas to condensed into water drops. We carried out five tests on each sensor sample and sampled the greatest one of the water mark percentages as data on each sensor sample plotted in the graph of FIG. 12.

The graph shows that the smaller the water contact angle of the cover assembly 3, the lower the water mark percentage will be, and that when the water contact angel is 70° or less, the water mark percentage will be 20% or less, and when the water contact angel is 60° or less, the water mark percentage will be 15% or less.

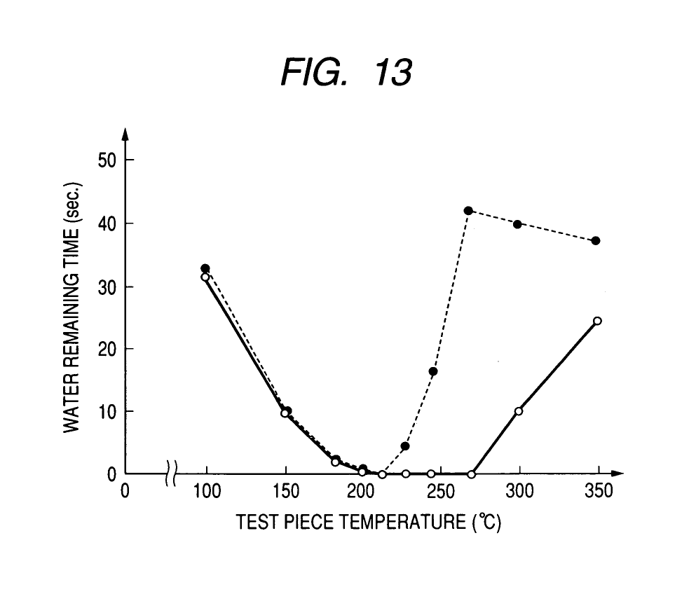

FIG. 13 demonstrates a relation between the temperature of test pieces and the time for which a water drop remains on the test piece being heated.

We prepared, as test pieces, two types of Inconel plates: one having a water-wettability of 90°, and the other having a water-wettablity of 65°, put a water drop of 5 μL on the test pieces heated to temperatures different from each other, and measured the time consumed until the water drop disappears.

In the graph of FIG. 13, “●” indicates data on the test pieces having a water-wettability of 90°. “◯” indicates data on the test pieces having a water-wettablity of 65°. As can be seen from the graph, the water remaining time decreases regardless of the water wettability as the temperature of the test pieces rises within a range of less than 210° C. The water drop vaporizes instantaneously at approximately 210° C. When the temperature of the test pieces exceeds 210° C., some of them having a water-wettability of 90° increases in the water remaining time, while the other of them having a water-wettability of 65° capable of holding the water drop from vaporizing until approximately 270° C.

Usually, the temperature of the sensor element 2 of the gas sensor 1 is elevated up to 100° C. to 300° C. at the start of typical internal combustion engines. It is, thus, found that in use of the gas sensor 1 in an exhaust system of the internal combustion engine, the cover assembly 3 having a water-wettablity of 65° serves to facilitate quick vaporization of water drops.

The reason that the water remaining time decreases regardless of the water-wettability as the temperature of the test pieces rises within a range of less than 210° C. is because the whole of the water drop is subjected to the heat so that it vaporizes. When a water drop is put on the test pieces which is higher in temperature than 210° C. and has a greater water-wettability, the water drop undergoes the film boiling, thus resulting in an increase in the water remaining time. When the test pieces have a smaller water-wettability, the water drop does not undergo the film boiling as long as the temperature of the test pieces is elevated further, so that the water remaining time remains unchanged.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

For instance, either of the inner cover 31 or the outer cover 32 may be covered with a porous film of the type, as described above. The porous film may occupy the whole or a portion of the inner and/or outer surface of the inner cover 31 or the outer cover 32. It is advisable that at least one of the outer surface 312 of the inner cover 31 and the inner surface 321 of the outer cover 32 be covered with the porous film between the gas inlets 33 of the inner cover 31 and the gas inlets 33 of the outer cover 32, that is, that a portion of the outer surface 312 of the inner cover 31 or the inner surface 321 of the outer cover 32 which is exposed to a gas path extending from the outer cover 32 to inside the inner cover 31 in order to ensure the stability in avoiding the entrance of water drops into the inner cover 31. The porous film may be formed only the outer surface 312 of the inner cover 31 or both the outer surface 312 of the inner cover 31 and the inner surface 321 of the outer cover 32. Instead of the cover assembly 3, a single-wall cover may be employed which has a water-wettability of 70° or less.

What is claimed is:

1. A gas sensor comprising:
a sensor element sensitive to a specified component of gases to provide a signal as a function of concentration of the specified component; and
a cover covering the sensor element, the cover having gas inlets through which the gasses pass and enter a gas chamber to which the sensor element is exposed within the cover, the cover having formed thereon a hydrophilic film which enhances wettability of a surface of the cover.

2. A gas sensor as set forth in claim 1, wherein the cover is of a double-wall structure made up of an outer cover and an inner cover, and wherein the hydrophilic film is coated on an outer surface of the inner cover.

3. A gas sensor as set forth in claim 2, further comprising a hydrophilic film formed on an inner surface of the outer cover.

4. A gas sensor as set forth in claim 1, wherein the hydrophilic film has a water-wettability of 70° or less, as expressed by a water contact angle.

5. A gas sensor as set forth in claim 1, wherein the hydrophilic film has a water-wettability of 60° or less, as expressed by a water contact angle.

6. A gas sensor as set forth in claim 1, wherein the hydrophilic film is made of an inorganic porous material.

7. A gas sensor as set forth in claim 1, wherein the hydrophilic film is implemented by an oxide film formed on said cover made of metal.

8. A gas sensor as set forth in claim 7, wherein the oxide film is formed by thermally treating said cover in air.

9. A gas sensor as set forth in claim 6, wherein the porous material is a sintered metal.

10. A gas sensor comprising:
a sensor element sensitive to a specified component of gases to provide a signal as a function of concentration of the specified component; and
a cover covering said sensor element, said cover having gas inlets through which the gasses pass and enter a gas chamber to which said sensor element is exposed within said cover, said cover having a surface reformed to have an enhanced water-wettability.

11. A gas sensor as set forth in claim 10, wherein said cover is of a double-wall structure made up of an outer cover and an inner cover, an outer surface of the inner cover being reformed to have the enhanced water-wettability.

12. A gas sensor as set forth in claim 11, wherein an inner surface of the outer cover is also reformed to have an enhanced water-wettability.

13. A gas sensor as set forth in claim 10, wherein the enhanced water-wettability of the surface of said cover is 70° or less, as expressed by a water contact angle.

14. A gas sensor as set forth in claim 10, wherein the enhanced water-wettability of the surface of said cover is 60° or less, as expressed by a water contact angle.

15. A gas sensor as set forth in claim 10, wherein the outer surface of the inner cover is mechanically treated to have the enhanced water-wettability.

16. A gas sensor as set forth in claim 10, wherein the outer surface of the inner cover is electrochemically treated to have the enhanced water-wettability.

17. A gas sensor comprising:
a sensor element sensitive to a specified component of gases to provide a signal as a function of concentration of the specified component; and
a cover covering said sensor element, said cover having gas inlets through which the gasses pass and enter a gas chamber to which said sensor element is exposed within said cover, said cover being made of an inorganic porous material having a water-wettability of 70° or less, as expressed by a water contact angle.

18. A gas sensor as set forth in claim 17, wherein the porous material is a sintered metal.

19. A gas sensor comprising:
a sensor element sensitive to a specified component of gases to provide a signal as a function of concentration of the specified component; and
a cover assembly cover covering said sensor element, said cover having gas inlets through which the gasses pass and enter a gas chamber to which said sensor element is exposed within said cover assembly, said cover assembly being of a double-wall structure made up of an outer cover and an inner cover disposed inside the outer cover, at least one of an outer surface of the inner cover and an inner surface of the outer cover having a water-wettability of 70° or less, as expressed by a water contact angle.

20. A gas sensor as set forth in claim 19, wherein the at least one of the outer surface of the inner cover and the inner surface of the outer cover has a water-wettability of 60° or less, as expressed by a water contact angle.

21. A gas sensor as set forth in claim 19, wherein the at least one of the outer surface of the inner cover and the inner surface of the outer cover is smaller in water-wettability than an outer surface of the outer cover.

22. A gas sensor as set forth in claim 19, wherein the at least one of the outer surface of the inner cover and the inner surface of the outer cover is coated with an inorganic porous material.

23. A gas sensor as set forth in claim 19, wherein at least one of the inner cover and the outer cover is made of an inorganic porous material.

24. A gas sensor as set forth in claim 22, wherein the porous material is made of a thermally sprayed film

25. A gas sensor as set forth in claim 24, wherein the inner cover and the outer cover are each made of a stainless steel, and wherein the thermally sprayed film is made of a stainless steel.

26. A gas sensor as set forth in claim 19, wherein the inner cover and the outer cover are both made of a porous material.

27. A gas sensor as set forth in claim 23, wherein the porous material is a sintered metal.

28. A gas measuring apparatus for an internal combustion engine comprising:
an exhaust pipe leading to an internal combustion engine;
a gas sensor installed in said exhaust pipe, said gas sensor being sensitive to a specified component of gases to provide a signal as a function of concentration of the specified component; and
a hydrophilic film affixed to an inner wall of said exhaust pipe at a location upstream of said gas sensor, said hydrophilic film having a water-wettability of 70° or less, as expressed by a water contact angle.

29. A gas measuring apparatus for an internal combustion engine comprising:
an exhaust pipe leading to an internal combustion engine; and
a gas sensor installed in said exhaust pipe, said gas sensor being sensitive to a specified component of gases to provide a signal as a function of concentration of the specified component,
wherein a portion of an inner wall of said exhaust pipe located upstream of said gas sensor is reformed to have a water-wettability of 70° or less, as expressed by a water contact angle.
